(19) United States
(12) Patent Application Publication
(10) Pub. No.: US 2023/0347292 A1
(43) Pub. Date: Nov. 2, 2023

(54) MULTI-STAGE MEMBRANE DISTILLATION DEVICE AND METHOD

(71) Applicant: KING ABDULLAH UNIVERSITY OF SCIENCE AND TECHNOLOGY, Thuwal (SA)

(72) Inventors: Peng WANG, Thuwal (SA); Wenbin WANG, Thuwal (SA); Yunpeng ZHOU, Thuwal (SA)

(21) Appl. No.: 18/016,895

(22) PCT Filed: Jul. 16, 2021
(86) PCT No.: PCT/IB2021/056467

§ 371 Date: Jan. 19, 2023

Related U.S. Application Data
(60) Provisional application No. 63/057,028, filed on Jul. 27, 2020.

(51) Int. Cl. B01D 61/36

(52) U.S. Cl. CPC B01D 61/3641; B01D 61/366; B01D 2313/54; B01D 2313/56

(57) ABSTRACT

A method for assembling a scalable, multi-stage membrane distillation module includes providing plural thermal conduction layers, plural first gaskets, plural membranes for distilling water, and plural second gaskets, where a periphery of each layer and gasket has plural holes formed all around the periphery, stacking on top of each other a first thermal conduction layer, a first gasket, a first membrane, and a second gasket, to form a first stage, stacking on top of each other, and also on top of the first stage, a second thermal conduction layer, a third gasket, a second membrane, and a fourth gasket, to form a second stage, placing plural bolts through the plural holes formed all around the periphery of each layer and each gasket of the first and second stages, and tightening with nuts the plural bolts to form one evaporation layer and one condensation layer for each of the first and second stages.

### CROSS-REFERENCE TO RELATED APPLICATIONS

This application claims priority to U.S. Provisional Pat. Application No. 63/057,028, filed on Jul. 27, 2021, entitled “FABRICATION OF MULTISTAGE MEMBRANE DISTILLATION DEVICE,” the disclosure of which is incorporated herein by reference in its entirety.

### BACKGROUND

### Technical Field

Embodiments of the subject matter disclosed herein generally relate to a multi-stage membrane distillation system, and more particularly, to a thermal based water multi-stage membrane distillation system that is capable of water desalination for various water sources.

### Discussion of the Background

Great efforts have been made in the past to shift the society’s energy reliance from fossil fuels to renewables, among which solar energy has shown its great potential to meet the future energy demands owing to its free availability and vast abundance. Through the photovoltaic effect, photovoltaic (PV) panels directly convert solar energy into electricity and thereby, large amounts of PV farms have been established all over the world. However, the theoretical energy efficiency of the PV panel is limited at 33.7% according to the Shockley-Quizzer limit, and the actual value is generally lower than 25% for most existing commercial PV panels. The rest of the absorbed solar energy is mainly converted into waste heat by the panels, which increases the temperature of the PV panels. The increased temperature of the PV panels in turn deteriorates their electricity generation efficiency.

Recently, a new technology, named photovoltaic-membrane distillation (PV-MD), was developed to simultaneously produce electricity and clean water. A PV-MD system 100, as shown in FIG. 1, uses a PV panel 110 and an underlying multi-stage membrane distillation module 120. The MD module 120 includes thermal conduction layers 122, evaporation layers 124, condensation layers 126, and membranes 128, as schematically shown in FIG. 1. A water feed is provided to the evaporation layers 124 and heat is provided through the thermal conduction layers to evaporate the water. The water vapors pass through the membranes 128 into the condensation layers 126, where the vapors are condensed to generate fresh water. The process utilizes the waste heat generated from the PV panel 110 to power the multistage MD process discussed above.

More specifically, each stage of the MD module 120 includes an evaporation layer 124, porous hydrophobic membrane layer 128, condensation layer 126, and thermal conduction layer 122. The source water flows into the evaporation layer 124 and then gets evaporated. The generated vapor subsequently passes through the porous hydrophobic membrane 128 and condenses in the condensation layer 126. The condensation process releases the latent heat of the vapor, which is subsequently transferred through the next thermal conduction layer 122 into the next stage, as the heat source. This technology breaks the limit of the water production efficiency of a conventional solar still and provides a promising strategy to contribute to an enhanced water-energy nexus.

However, manufacturing the multi-stage MD module 120 is still plagued by a cumbersome assembling process and sometime a failure of attaching the various components to each other. Also, as the various layers of the MD module are permanently attached to each other by welding or gluing, and thus, the traditional MD modules are not scalable. Therefore, there is a need for a new multi-stage MD module and method of manufacturing that overcomes the limitations of the existing MD modules.

### BRIEF SUMMARY OF THE INVENTION

According to an embodiment, there is a method for assembling a scalable, multi-stage membrane distillation module, and the method includes providing plural thermal conduction layers, plural first gaskets, plural membranes for distilling water, and plural second gaskets, where a periphery of each layer and gasket has plural holes formed all around the periphery, stacking on top of each other a first thermal conduction layer of the plural thermal conduction layers, a first gasket of the plural first gaskets, a first membrane of the plural membranes, and a second gasket of the plural second gaskets, to form a first stage, stacking on top of each other, and also on top of the first stage, a second thermal conduction layer of the plural thermal conduction layers, a third gasket of the plural first gaskets, a second membrane of the plural membranes, and a fourth gasket of the plural second gaskets, to form a second stage, placing plural bolts through the plural holes formed all around the periphery of each layer and each gasket of the first and second stages, and tightening with nuts the plural bolts to form one evaporation layer and one condensation layer for each of the first and second stages.

According to another embodiment, there is a scalable, multi-stage membrane distillation module that includes plural thermal conduction layers, plural first gaskets, plural membranes for distilling water, plural second gaskets, wherein a periphery of each layer and gasket has plural holes formed all around a periphery, plural bolts, each extending through corresponding holes of the plural holes for each layer and gasket, and plural nuts connected to the plural bolts to seal plural evaporation layers defined by the plural second gaskets and plural condensation layers defined by the plural first gaskets.

According to yet another embodiment, there is a scalable, multi-stage membrane distillation module that includes plural thermal conduction layers, plural perforated plates, plural membranes for distilling water, plural gaskets, where a periphery of each layer, gasket, and perforated plate has plural holes formed all around a periphery, plural bolts, each extending through corresponding holes of the plural holes for each layer, gasket, and perforated plate, and plural nuts connected to the plural bolts to seal plural evaporation layers defined by the plural gaskets and plural condensation layers defined by the plural perforated plates.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a multi-stage MD module;

FIGS. 2A to 2C illustrate a scalable, multi-stage MD module that uses removable means for maintaining together the various components;

FIGS. 3A to 3D illustrate another scalable, multi-stage MD module that uses removable means for maintaining together the various components;

FIGS. 4A to 4D illustrate yet another scalable, multi-stage MD module that uses removable means for maintaining together the various components;

FIGS. 5A to 5C illustrates a scalable, multi-stage MD module that uses perforated plates for the condensation layers and removable means for maintaining together the various components; and

FIG. 6 is a flow chart of a method for assembling the various components for forming a scalable, multi-stage MD module.

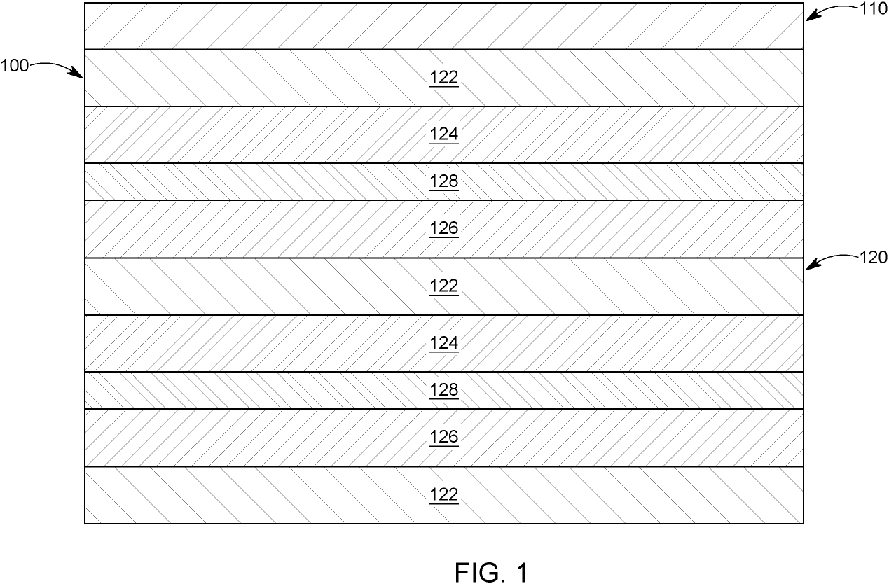

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a multi-stage MD module that is attached to a PV panel for cooling down the panel and also for generating fresh water. However, the embodiments to be discussed next are not limited to a PV panel, or to both cooling and desalination, but may be applied to other systems and/or for only cooling or only desalination.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel strategy to fabricate a detachable and scalable multi-stage membrane distillation module includes using various components that are built in top of each other, depending on the number of stages that are desired, and these components are maintained attached to each other with mechanical fasteners, for example, nuts and bolts. An N-stage MD module, where N is a whole number equal to or larger than 2, may include any desired number of stages. One or more stages may be added or removed as necessary, after the N-stage MD module has been fully assembled, making the module highly scalable. In other words, any stage of the N-stage MD module is replaceable by just temporary removing the mechanical fasteners. No glue or permanent fastener is used so that any stage can be replaced at any time. In one application, a stage can be removed or added as the MD module is attached to the PV panel or another system. Various heat sources can be utilized to power the multi-stage MD module, including a PV panel, photothermal material, or an electrical heater, among others. The multi-stage MD module can be directly attached on the backside of the heat source and desalinate the raw source water by multiple evaporation-condensation cycles.

The benefits of this novel module and process include, but are not limited to: (1) the fabrication process is simple and allows the addition or removal of any number of stages without damaging the unit; (2) the module is detachable, which means that some of the components in the device can be easily replaced once it is damaged or aged; and (3) a large scale device can be fabricated by this process and an automatic production can be implemented. A couple of possible implementations of the N-stage MD module and its manufacturing process are now discussed in more detail.

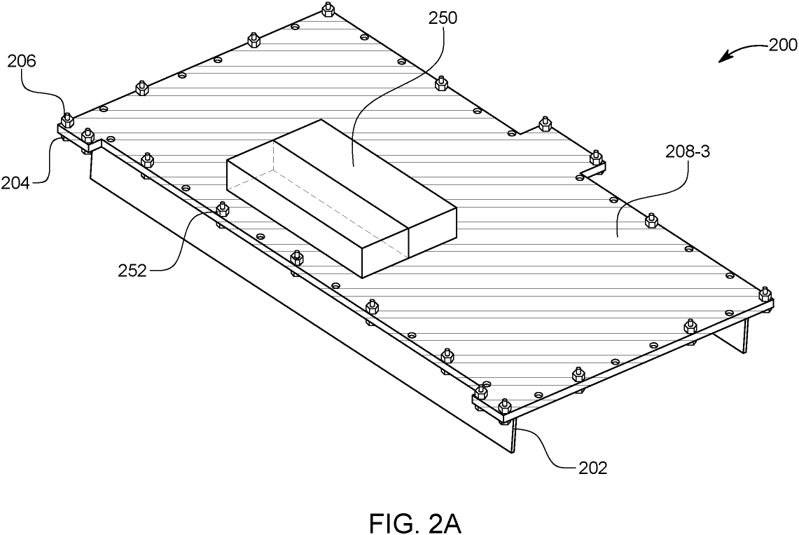

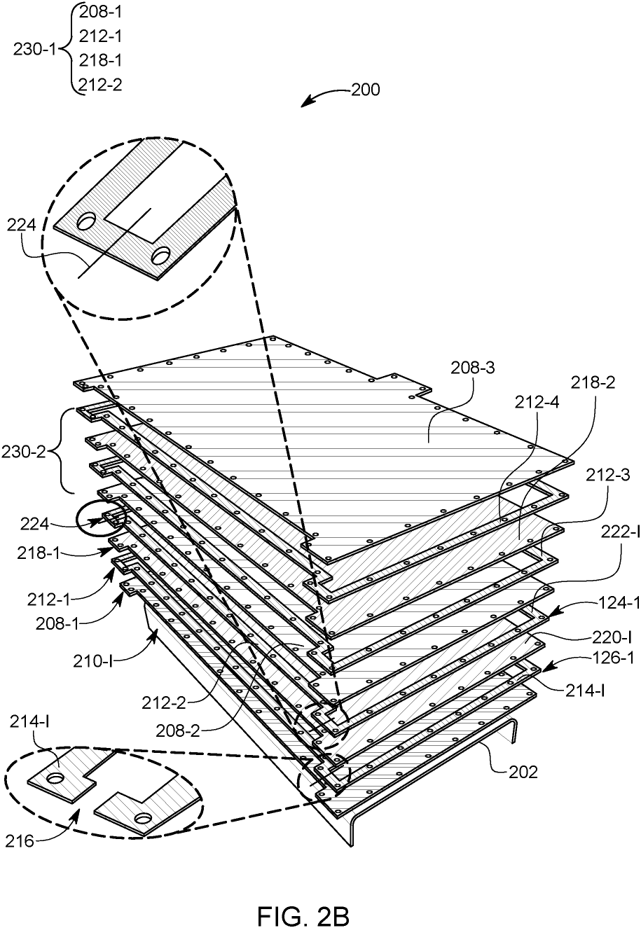

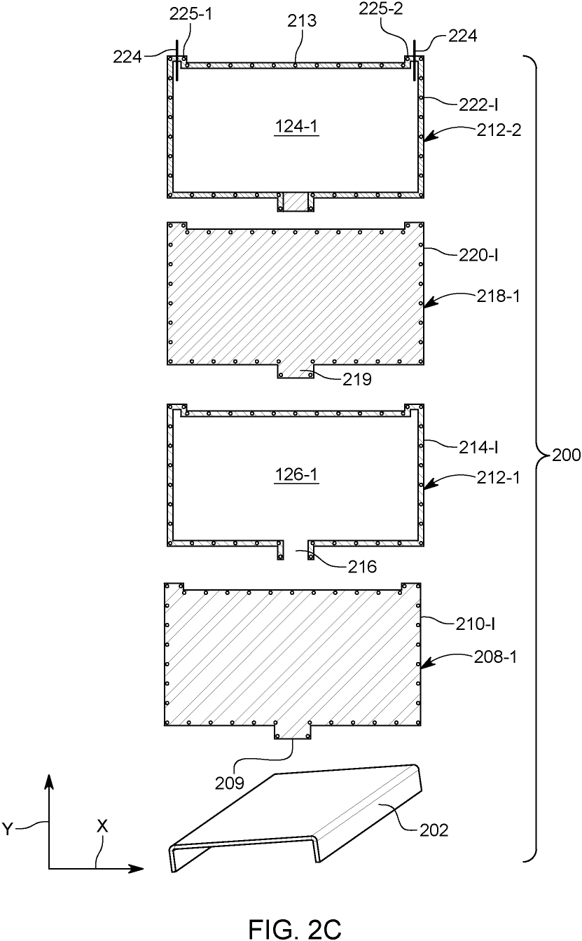

FIGS. 2A to 2C illustrate a first such implementation in which an assembled, scalable, N-stage MD module 200 is shown having two stages provided on top of each other and also on top of an evaporation cooling element 202. The evaporation cooling element 202 may be made of a material that possess hydrophilicity and porous structures (such as non-woven fabrics, silica fiber, glass fiber, etc.). Its thickness should be between 0.05 and 200 mm.

The stages are attached to each other and to the evaporation cooling element 202 by nuts 206 and bolts 204, as also shown in the figure. The material of the bolt can include metallic materials or polymers, such as stainless steel, zinc-plated, polytetrafluoroethylene. The number of bolts on each side should be more than one. FIG. 2B shows the module 200 in an exploded view, with all the layers separated from each other, for better visualization of the various features. Starting from the evaporative cooling element 202, FIG. 2B shows a first thermal conduction layer 208-1 having plural holes 210-1, which are sized to accommodate the bolts 204. A thickness of the thermal conduction layer should be between 0.001 and 2 mm. The thermal conduction layer should possess good thermal conductivity, i.e., it should be made from one or more of copper (401 W/mK), zinc (116 W/mK), aluminum (237 W/mK), brass (109 W/mK), bronze (110 W/mK), graphite (168 W/mK), Ag (429 W/mK), silicon carbide (360-490 W/mK), iron (73 W/mK), stainless Steel (12- 45 W/mK), tin (62-68 W/mK), and thermal conductive plastic material. When the thickness of the thermal conduction layer is thinner than 1 mm, the thermal conduction layer can also be made of some plastic material with a low thermal conductivity, such as polypropylene, polyethylene, etc.

Next, a first gasket 212-1 is placed directly over the thermal conduction layer 208-1, at its periphery, to define the edges of the first condensation layer 126-1, which is shown in FIG. 2C. The first gasket 212-1 is shaped to fit a perimeter of the first thermal conduction layer 208-1 and no glue is used to connect the two elements. The first gasket is made of a polymer, plastic, or rubber. The gaskets of the evaporation layer and the condensation layer are made of a material that possess good sealability, such as rubber, silicon rubber, fluoro-rubber, etc. Its thickness can be between 0.1 and 2 mm and the width can be between 1 and 400 mm.

The first gasket 212-1 has plural holes 214-l that correspond to the holes 210-l formed on the periphery of the first thermal conductive plastic material 208-1. These holes are sized to receive corresponding bolts 204. The first gasket 212-1 is formed continuously around the perimeter of the first thermal conduction layer 208-1 so that no fluid can escape from the condensation layer 126-1. However, there is a single channel 216 (generically called herein a port), in this embodiment, that extends through the entire width of the first gasket 212-1, into the condensation layer, so that a fluid that accumulates in the first condensation layer 126-1 is allowed to exit the layer. While the channel 216 is shown in FIG. 2B as being formed at one end of the module 200, the channel 216 can be formed at the middle of the module, as shown in FIG. 2C. FIG. 2C also shows that the channel 216 is formed over a platform 209 that is part of the first thermal conduction layer 208-1. This means that all the other layers have the same platform or extension, e.g., the membrane 218-1 has a corresponding platform 219. Note that the term “platform” is defined herein as being an extension of a layer, beyond a side of the layer and the extension has a length less than half of the length of the side. The first condensation layer 126-1 may be empty or can be filled with some porous materials (such as non-woven fabrics, silica fiber, glass fiber, etc.).

Next, a first membrane 218-1 is placed over the first gasket 212-1 to fully enclose the first condensation layer 126-1. The first membrane 218-1 may be a hydrophobic layer, which may be porous. To increase the temperature gradient, the hydrophobic layer should also possess low thermal conductivity or it can be composed of two or more kinds of materials, some of which possess low thermal conductivity such as polystyrene membrane, polyvinylidene fluoride, poly tetra fluoroethylene, etc. Any other type of membrane may be used as long as the membrane allows water vapors to pass through and prevents the water droplets to pass through. The first membrane 218-1 is sized to fully cover the first gasket 212-l and it also has plural holes 220-l that match the plural holes 214-l in the first gasket and also the plural holes 210-l in the first thermal conduction layer 208-1, so that the bolts 204 enter through all these holes.

Next, a second gasket 212-2 is placed over the first membrane 218-1, to define the border of the first evaporation layer 124-1. The second gasket 212-2 may have the same shape and composition as the first gasket 212-1. The second gasket 212-2 is configured to cover a perimeter of the first membrane 218-1 and to have plural holes 222-l, which correspond to the plural holes 220-l in the first membrane 218-1, the plural holes 214-l in the first gasket, and also the plural holes 210-l in the first thermal conduction layer 208-1, so that the bolts 204 enter through all these holes. The second gasket 212-2 has a first pipe 224 (generically called herein a port) at one location and a second pipe 224 at a second location and the two pipes extend all the way through the width of the second gasket to fluidly communicate the first evaporation layer 124-1 to the outside. FIG. 2C shows the second gasket 212-2 having two platforms 225-1 and 225-2 that extend in the X-Y plane, beyond a side 213 of the gasket, and the two pipes 224 are located on the two platforms, respectively.

For this embodiment, all the components of the module (i.e., the thermal conduction layer, the first gasket, the membrane and the second gasket) are configured to have two platforms (corresponding to platforms 225-1 and 225-2) that extend past a main side 213. In one embodiment, each platform has one or more corresponding holes for receiving a corresponding bold and nut. The first pipe may be used to provide the feed from the water source (not shown) inside the first evaporation layer and the second pipe may be used to discharge the brine resulting after the evaporation of the water. The water source can be seawater, lake water, river water, groundwater, industrial wastewater, brine, brackish water, etc. These source waters can be of impaired quality and can be contaminated with heavy metals, organics, radioactive materials, pesticides, or any other chemicals with health and environmental concerns. In one application, more than two pipes may be used for the evaporation layer.

The layers discussed above form the first stage 230-1 of the scalable, N-stage MD module 200. Next a second stage 230-2 may be formed, by adding a second thermal conduction layer 208-2, a third gasket 212-3, a second membrane 218-2, and a fourth gasket 212-4, as also shown in FIG. 2A. All the additional thermal conduction layers, gaskets, and membranes have the same configuration as the previous layers, i.e., the same shape and perimeter and the same distribution of the plural holes so that the bolts 204 can enter through all of them at the same time. The last stage has an additional thermal conduction layer 208-3 for closing the last evaporation layer. In the embodiment shown in FIG. 2B, only two stages 230-1 and 230-2 are present. However, due to the system of holes and bolts discussed herein, any number of stages can be added or removed from an existing scalable, multi-stage MD module 200 as the addition of further layers require just providing longer bolts 204. In one application, a stage may be configured differently from another stage. In one application, if the membrane of a certain stage is clogged and needs to be changed, the nuts and bolts are removed, the membrane is replaced with another one, and then the stages are attached together with the same or other nuts and bolts.

This means that the various components discussed herein are easily removed after the nuts 206 are unscrewed from the bolts 204 as there is no gluing or welding, i.e., no permanent and irreversible attachment of any two components. In other words, because all the components are not-permanently attached to each other due to the tension exerted by the bolts 204 and nuts 206, the module 200 can be scaled up or down as desired, i.e., entire stages may be added or removed, not only layers. In addition, by having the various component layers pre-manufactured, a relatively not skilled person can easily remove or add additional stages to the existing module 200, as necessary. In other words, if a PV farm is equipment with this novel module 200, after some time of running the farm, if the operator decides that the PV panels are too hot, a person with relatively low skills can scale up the module 200, for each panel PV, to increase the cooling degree of that panel. It is noted that the scaling up or down can take place while the module 200 is deployed in the field, as the scaling require only to remove the bolts, to add or remove some layers and gaskets, and to compress these components with smaller or larger bolts, depending on the situation.

In this regard, FIG. 2A shows a PV panel 250 placed on top of the module 200. The PV panel 250 may be permanently attached (e.g., gluing, welding, etc.) to the top most thermal conduction layer 208-3, as shown in the figure, or the PV panel 250 (or any other device that needs to be cooled) may be provided with plural holes 252, that correspond to the plural holes made in the periphery of the module 200, so that the same bolts 204 and nuts 206 are used to removably attach the PV panel 250 to the module 200. Note that the module 250 is not shown at scale in the figure and thus, the module may have any size relative to the top surface of the top most thermal conduction layer 208-3. For simplicity, the following embodiments do not show the device 250 placed on top of the scalable, multi-stage MD module, but it is understood that all the modules now discussed are configured to be attached to such a corresponding device, for example, a PV panel.

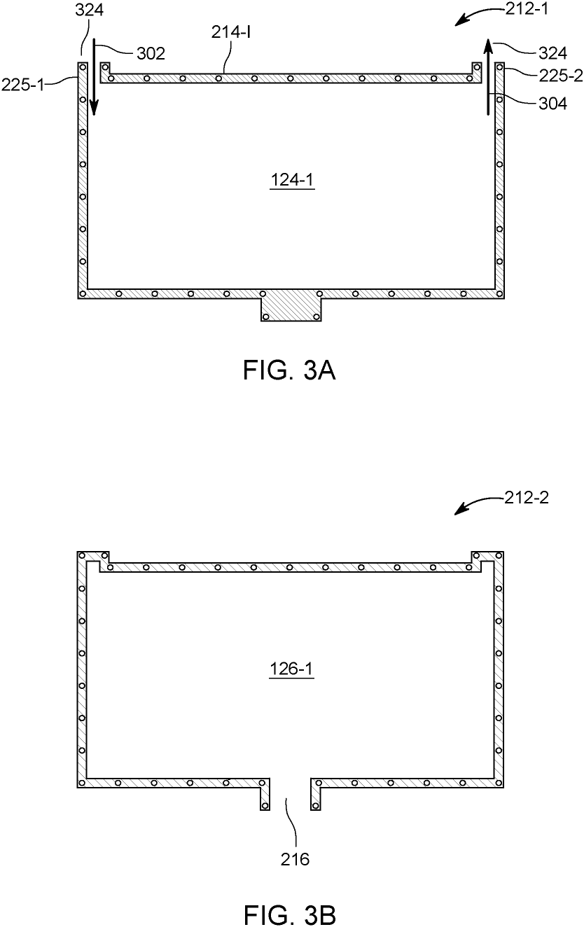

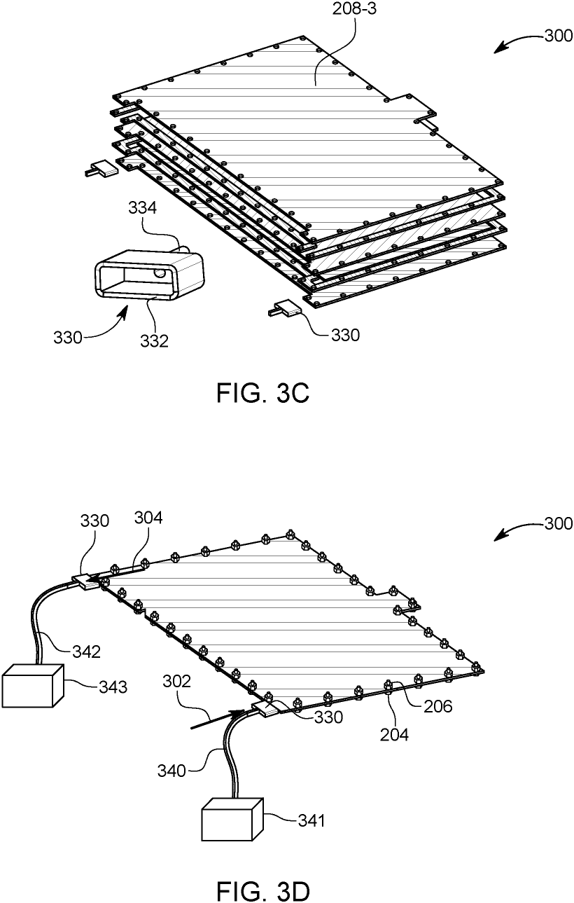

In a variation of the module 200, FIGS. 3A to 3D shows a scalable, N-stage, MD module 300 that is similar to the module 200, except that the first gasket 212-1 has two openings 324 instead of the pipes 224 shown in FIGS. 2B and 2C. The two openings 324 are located on the two platforms 225-1 and 225-2, as shown in FIG. 3A and they are configured to allow a feed 302 to flow inside the first evaporation layer 124-1 and a brine 304 to flow out of the same layer. FIG. 3B shows the condensation layer 126-1 having the single channel 216. FIGS. 3C and 3D show a connecting tube 330 that can be placed over the openings 324 to close the openings and to direct the feed or brine into or out of the evaporation layer.

In one embodiment, the connecting tube 330 is made to have a large opening 332 that fits over all the platforms 225-1 (not only the platform of the first gasket, but also over the corresponding platforms of the thermal conduction layer, the second gasket, and the membrane) and a narrow port 334 that is configured to be connected to a supply pipe, and the narrow port 334 fluidly communicate with the large opening 332. The connecting tube may be made of a flexible material, for example, rubber, so that the connecting tube slides over all the platforms of all the stages of the device 300, including the openings 324, and seals them. There is no need to use any fastening means for attaching the connecting tube 330 to the openings 324 as the connecting tube is stretchable and the large opening 332 is configured to be slightly smaller than the footprint of the combined platforms of the module 300, so that the connecting tube is stretched over all the openings 324 of all the stages, as shown in FIG. 3D. Note that the module 300 in FIG. 3D may include many stages and the connecting tube 330 simultaneously connects to all the platforms of all the stages, thus effectively connecting the evaporation layers 124-l in parallel to each other. This means that the feed 302 simultaneously enters all the evaporation layers and the brine 304 simultaneously leaves all the evaporation layers. This also means that there is only one supply pipe 340 (for the feed) for the entire module 300 and only one discharge pipe 342 (for the brine) for the entire module. The supply pipe 340 may be connected to a supply source 341 and the discharge pipe 342 may be connected to a discharge container. In this way, the manufacturing process is further simplified as there is no need to puncture the gaskets for introducing the pipes 224, as in the module 200, and also there is no need to connect each evaporation layer to another evaporation layer or directly to the water source. In other words, when the various layers of the module 300 are assembled, the connecting tube 330 simply slides over all the openings 324 of all the stages. While the platforms 225-1 and 225-2 shown in the previous embodiments are sized to be rectangular, it is possible to size them to have different shapes, for example, square, hexagonal, semi-circular, etc.

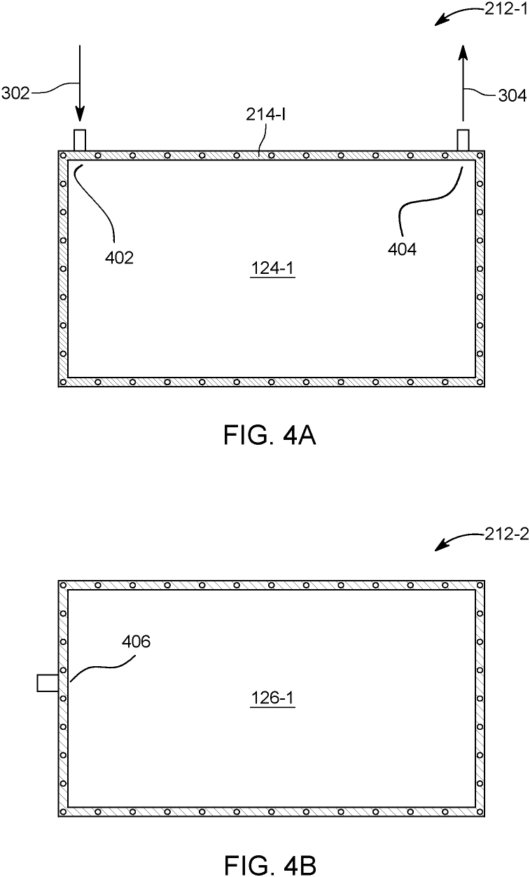

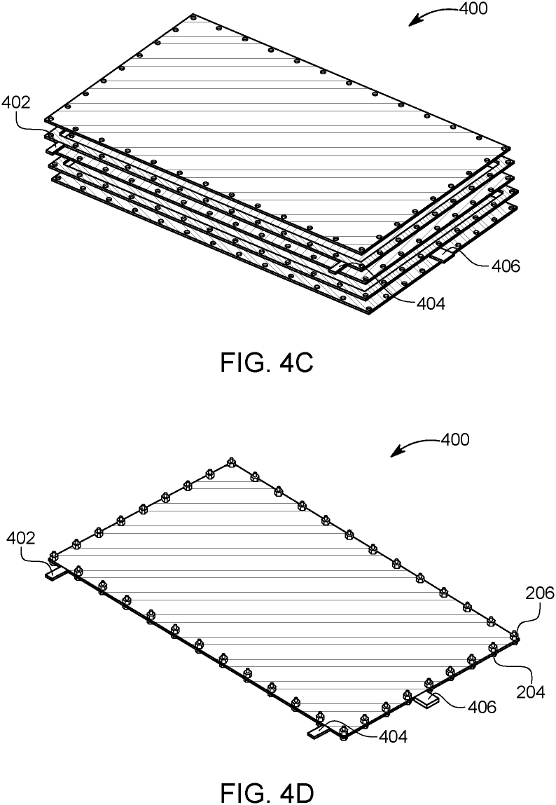

In a different embodiment, as shown in FIGS. 4A to 4D, there are no platforms for the channel 216 and for the ports/pipes 224 or the openings 225-1 and 225-2. FIG. 4A shows that the first gasket 212-1 is shaped as a rectangle (other shapes may be used, for example, circular, square, triangular, hexagonal, etc.) with no platform, and pipes 402 and 404 are formed into or attached to the wall of the gasket to accept the feed 302 and to discharge the brine 304, respectively. FIG. 4B shows the second gasket 212-2 also having no platform, but having a corresponding pipe 406 (instead of the channel 216) for taking out the condensed water. In one embodiment, it is possible to combine this embodiment with the previous embodiments and to have platforms for some of the gaskets and layers, and no platform for the others. FIGS. 4C and 4D show the entire module 400 with only the pipes 402, 404, and 406 protruding from the stack of layers.

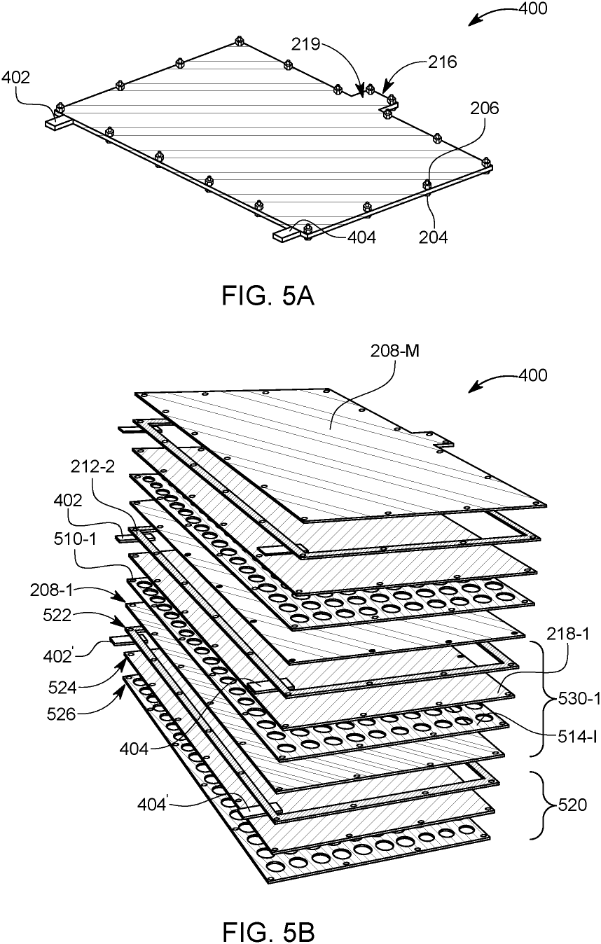

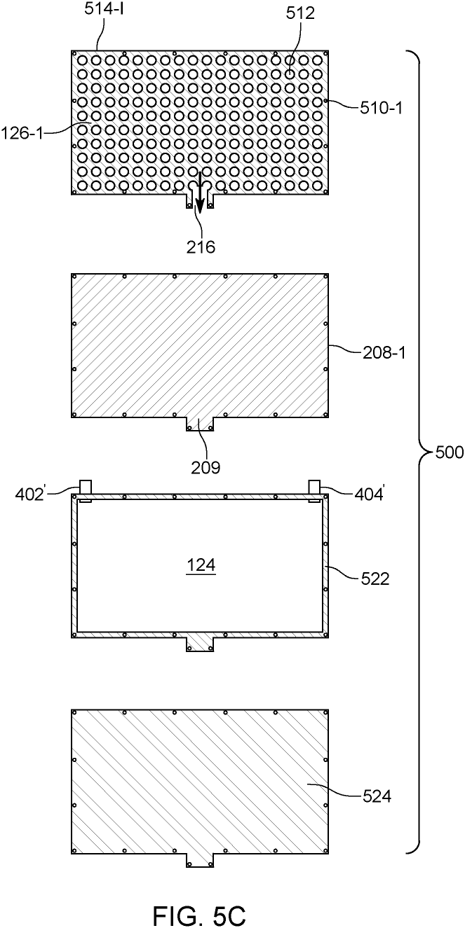

Another variation of the module 200 is shown as module 500 in FIGS. 5A to 5C. More specifically, FIG. 5A shows the assembled module 500 having the pipes 402 and 404 with no platform for the evaporation layer, and having the channel 216 formed on a platform 219. FIG. 5B shows that the first gasket 212-1 (see module 200 in FIG. 2B), which defines the condensation layer 126-1, is now replaced by a first perforated plate 510-1. The first perforated plate 510-1 includes plural perforations or through holes or pores 512, see FIG. 5C, for collecting the vapors from the corresponding membrane, i.e., the generated vapor condenses in the pores 512 and the condensed water is collected at the channel 216, which sits on the platform 209 of the first thermal conduction layer 518. The first perforated plate 510-1 also includes plural peripheral holes 514-l (see FIG. 5C), that correspond to the peripheral holes of the other layers, and are configured to receive the bolts 204. FIG. 5B also shows the first membrane 218-1 formed over the first perforated plate 510-1, and the second gasket 212-2 formed over the first membrane 218-1, as in the module 400 or the other modules. This structure forms the first stage 530-1 of the module 500. One or more stages may be added over the first stage 530-1. Note that it is possible to combine a stage (having the perforated plate) from this module with a stage (with no perforating plate) from the previous modules into the same MD module.

Different from the previous embodiments, the first thermal conduction layer 208-1 is formed on a cooler 520, which includes a gasket 522 having pipes 402′ and 404′, similar to the first gasket 212-1, and the pipes 402′ and 404′ have no platforms. The gasket 522 defines an evaporation layer 124 and the gasket is located on a membrane 524, which is also part of the cooler 520. The cooler 520 further includes a perforated plate 526 that holds the membrane 524 and acts as an evaporation layer to dissipate the residual latent heat of the condensation layer of the first stage. Thus, the vapor that passes the membrane 524 into the perforated plate 526 is released directly into the environment and the cooler 520 acts as a heat sink for the first stage 530-1 of the module 500. The cooler 520 may be added to any of the previously discussed scalable, multi-stage MD modules. The pipes 402 and 404 and even the pipes 402′ and 404′ in this embodiment can be individually connected to a feed supply pipe and a brine discharge pipe, or they may be connected in parallel, by using the connection tube 330 shown in FIGS. 3C and 3D.

In all the embodiments discussed above, the top most thermal conduction layer (e.g., layer 208-M, where M is the number of stages) is configured to be attached directly to the PV panel, or other device that needs to be cooled. The heat from the PV panel is transmitted by the top most thermal conduction layer 208-M to the evaporation layer below, to heat the feed in the evaporation layer 124. The heat promotes the water evaporation and the generated vapors pass through the membrane 128 into the condensation layer 126. The membrane prevents the water to pass into the condensation layer 126 and thus, the generated brine is discharged from the evaporation layer. The heat of the condensed water in the condensation layer is then passed to the next thermal conduction layer for heating the brine or feed in the next evaporation layer, and this process repeats itself for each stage of the module.

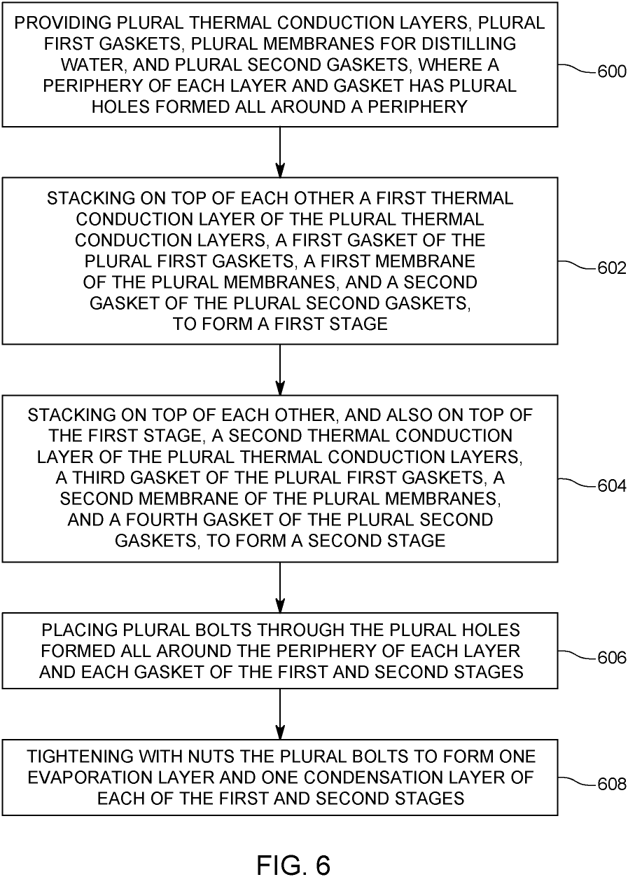

A method for assembling a scalable, multi-stage membrane distillation module 200, 300 or 500 is now discussed with regard to FIG. 6. The method includes a step 600 of providing plural thermal conduction layers, plural first gaskets, plural membranes for distilling water, and plural second gaskets, where a periphery of each layer and gasket has plural holes formed all around a periphery, a step 602 of stacking on top of each other a first thermal conduction layer of the plural thermal conduction layers, a first gasket of the plural first gaskets, a first membrane of the plural membranes, and a second gasket of the plural second gaskets, to form a first stage, a step 604 of stacking on top of each other, and also on top of the first stage, a second thermal conduction layer of the plural thermal conduction layers, a third gasket of the plural first gaskets, a second membrane of the plural membranes, and a fourth gasket of the plural second gaskets, to form a second stage, a step 604 of placing plural bolts through the plural holes formed all around the periphery of each layer and each gasket of the first and second stages, and a step 606 of tightening with nuts the plural bolts to form one evaporation layer and one condensation layer for each of the first and second stages.

The method may further include a step of adding a cooling device at a bottom of the first stage, and/or a step of forming a single port in each of the plural first gaskets. The method may also include a step of forming first and second ports in each of the plural second gaskets, and/or a step of connecting the first ports of the plural second gaskets with a single first connecting tube, and/or a step of connecting the second ports of the plural second gaskets with a single second connecting tube. The method may further include a step of connecting the single first connecting tube to a feed source, and/or a step of connecting the single second connecting tube to a brine container. The method may additionally include a step of adding a cooling gasket to the first thermal conduction layer, on a side opposite to the first gasket, to form an evaporation layer, placing a membrane over the cooling gasket, and placing a perforated plate over the membrane to collect vapors that pass the membrane, where the cooling gasket, the membrane and the perforated plate form a cooling device. The method may also include a step of connecting the cooling device with the plural bolts to the first stage, and/or a step of removing the plural nuts from the plural bolts, adding a third stage to the first and second stages, and tightening the plural bolts with the plural nuts to form another evaporation layer and another condensation layer. Alternatively, the method may include removing the plural nuts from the plural bolts, removing the second stage, and tightening the plural bolts with the plural nuts.

The disclosed embodiments provide a scalable, multi-stage, MD module that can be attached to existing PV panels or other devices, for cooling the devices and/or distilling water in the process of cooling the devices. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for assembling a scalable, multi-stage membrane distillation module, the method comprising:
providing plural thermal conduction layers, plural first gaskets, plural membranes for distilling water, and plural second gaskets, wherein a periphery of each layer and gasket has plural holes formed all around the periphery;
stacking on top of each other a first thermal conduction layer of the plural thermal conduction layers, a first gasket of the plural first gaskets, a first membrane of the plural membranes, and a second gasket of the plural second gaskets, to form a first stage;
stacking on top of each other, and also on top of the first stage, a second thermal conduction layer of the plural thermal conduction layers, a third gasket of the plural first gaskets, a second membrane of the plural membranes, and a fourth gasket of the plural second gaskets, to form a second stage;
placing plural bolts through the plural holes formed all around the periphery of each layer and each gasket of the first and second stages; and
tightening with nuts the plural bolts to form one evaporation layer and one condensation layer for each of the first and second stages.

2. The method of claim 1, further comprising:
adding a cooling device at a bottom of the first stage.

3. The method of claim 1, further comprising:
forming a single port in each of the plural first gaskets.

4. The method of claim 3, further comprising:
forming first and second ports in each of the plural second gaskets.

5. The method of claim 4, further comprising:
connecting the first ports of the plural second gaskets with a single first connecting tube; and
connecting the second ports of the plural second gaskets with a single second connecting tube.

6. The method of claim 5, further comprising:
connecting the single first connecting tube to a feed source; and
connecting the single second connecting tube to a brine container.

7. The method of claim 1, further comprising
adding a cooling gasket to the first thermal conduction layer, on a side opposite to the first gasket, to define an evaporation layer;
placing a membrane over the cooling gasket to close the evaporation layer; and
placing a perforated plate over the membrane to collect vapors that pass through the membrane,
wherein the cooling gasket, the membrane and the perforated plate form a cooling device.

8. The method of claim 7, further comprising:
connecting the cooling device with the plural bolts to the first stage.

9. The method of claim 1, further comprising:
removing the plural nuts from the plural bolts;
adding a third stage to the first and second stages; and
tightening the plural bolts with the plural nuts to form another evaporation layer and another condensation layer.

10. The method of claim 1, further comprising
removing the plural nuts from the plural bolts;
removing the second stage; and
tightening the plural bolts with the plural nuts.

11. A scalable, multi-stage membrane distillation module comprising:
plural thermal conduction layers;
plural first gaskets;
plural membranes for distilling water;
plural second gaskets, wherein a periphery of each layer and gasket has plural holes formed all around a periphery;
plural bolts, each extending through corresponding holes of the plural holes for each layer and gasket; and
plural nuts connected to the plural bolts to seal plural evaporation layers defined by the plural second gaskets and plural condensation layers defined by the plural first gaskets.

12. The scalable, multi-stage membrane distillation module of claim 11,
wherein a first thermal conduction layer of the plural thermal conduction layers, a first gasket of the plural first gaskets, a first membrane of the plural membranes, and a second gasket of the plural second gaskets are stacked on top of each other to form a first stage, and
wherein a second thermal conduction layer of the plural thermal conduction layers, a third gasket of the plural first gaskets, a second membrane of the plural membranes, and a fourth gasket of the plural second gaskets, are stacked on top of each other to form a second stage, and the second stage is stacked on top of the first stage.

13. The scalable, multi-stage membrane distillation module of claim 12, further comprising:
a cooling device located at a bottom of the first stage.

14. The scalable, multi-stage membrane distillation module of claim 11, wherein each gasket of the plural first gaskets includes a single port.

15. The scalable, multi-stage membrane distillation module of claim 14, wherein each gasket of the plural second gaskets includes first and second ports.

16. The scalable, multi-stage membrane distillation module of claim 15, further comprising:
a single first connecting tube that connects the first ports of the plural second gaskets; and
a single second connecting tube that connects the second ports of the plural second gaskets.

17. The scalable, multi-stage membrane distillation module of claim 13, wherein the cooling device comprises:
a cooling gasket located on a first thermal conduction layer, on a side opposite to a first gasket, to define an evaporation layer;
a membrane located on the cooling gasket to close the evaporation layer; and
a perforated plate located the membrane to collect vapors that pass through the membrane.

18. The scalable, multi-stage membrane distillation module of claim 17, wherein the cooling device is connected with the plural bolts to a first stage.

19. The scalable, multi-stage membrane distillation module of claim 11, wherein a new stage is added or removed by removing the plural nuts, adding or removing corresponding layers, and tightening back the plural bolts with the plural nuts.

20. A scalable, multi-stage membrane distillation module comprising:
plural thermal conduction layers;
plural perforated plates;
plural membranes for distilling water;
plural gaskets, wherein a periphery of each layer, gasket, and perforated plate has plural holes formed all around a periphery;
plural bolts, each extending through corresponding holes of the plural holes for each layer, gasket, and perforated plate; and
plural nuts connected to the plural bolts to seal plural evaporation layers defined by the plural gaskets and plural condensation layers defined by the plural perforated plates.
